(19) United States
(12) Patent Application Publication
(10) Pub. No.: US 2007/0298287 A1
(43) Pub. Date: Dec. 27, 2007

(54) CIRCUIT BOARD DEVICE AND BATTERY PACK

(76) Inventors: Osamu Tajima, Atsugi-Shi (JP); Yoshiaki Miyamoto, Atsugi-Shi (JP)

Correspondence Address: LADAS & PARRY LLP, 224 SOUTH MICHIGAN AVENUE, SUITE 1600, CHICAGO, IL, 60604, US

(21) Appl. No.: 11/679,975

(22) Filed: Feb. 28, 2007

(30) Foreign Application Priority Data
Jun. 27, 2006 (JP) 2006-176971

(51) Int. Cl. H01M 14/00

(52) U.S. Cl. 429/7; 429/90

(57) ABSTRACT

A circuit board device is disclosed that is able to be made thin. The a circuit board device includes a substrate having a notch at one end thereof, plural electrical parts mounted on an upper surface of the substrate, a resin portion burying the electrical parts, a metal plate arranged at an end portion of the upper surface of the substrate to cover the notch, and a lead connected to the metal plate and extending from the end of the substrate to the outside. One end of the lead is fit into the notch and is welded to a back side of the metal plate for connection to the metal plate.

### BACKGROUND OF THE INVENTION

1. Field of the Invention

The present invention relates to a circuit board device, and particularly, to a protection-circuit board device having a spot-welded terminal block and used in a battery pack, and a battery pack.

2. Description of the Related Art

In portable terminal devices, such as a cellular phone, a battery pack is installed to work as a power supply.

Below, the structure of the battery pack is explained first.

FIG. 12A is an exploded perspective view illustrating a battery pack in the related art.

FIG. 12B is a cross-sectional view of the battery pack in FIG. 12A.

As shown in FIG. 12A and FIG. 12B, a battery pack 10 includes a cell 11, for example, which is a rechargeable lithium cell, a protection-circuit board device 12, a case 13, and a cover 14.

The protection-circuit board device 12 includes a substrate 20, plural electrical parts 21 mounted on the substrate 20, a resin portion 22 which buries the electrical parts 21, and leads 23, 24 connected to the two ends of the substrate 20.

The electrical parts 21 constitute a cell protection circuit which monitors a charging voltage and an output voltage of the cell 11, controls charging and recharging of the cell 11, and protects the cell 11.

The substrate 20 has plural electrodes 25 on the side opposite to the side where the electrical parts 21 are mounted.

The leads 23, 24 of the protection-circuit board device 12 are connected to the electrodes of the cell 11.

The cell 11 and the protection-circuit board device 12 are accommodated in the case 13. In the protection-circuit board device 12, the resin portion 22 faces the cell 11 and the electrodes 25 are exposed to the outside through a notch 13a of the case 13.

It is required that the battery pack 10 have a large capacity without increasing the size thereof. For this purpose, it is effective to make the volume of the cell 11 as large as possible. In order to increase the volume of the cell 11, for example, the thickness t1 of the protection-circuit board device 12 can be made as thin as possible so that the length A of the cell 11 can be increased accordingly. Even though the increase of the length A is as small as 0.1 mm, since the cell 11 is a rectangle having an area A×B when viewed from the top, the volume of the cell 11 increases sufficiently, and this contributes to capacity increase of the battery pack 10.

FIG. 13A and FIG. 13B are perspective views illustrating a protection-circuit board device 30 in the related art.

FIG. 14A and FIG. 14B are a top view and a cross-sectional view of the protection-circuit board device 30.

As shown in FIG. 13A, FIG. 13B, FIG. 14A, and FIG. 14B, the protection-circuit board device 30 includes an elongated rectangular substrate 31, plural electrical parts 32 mounted on the upper surface 31a of the substrate 31, a resin portion 33 burying the electrical parts 32, electrodes 31c on the lower surface 31b of the substrate 31, nickel plates 34, 35 connected, by soldering, to lands (not illustrated) on the two ends of the upper surface 31a of the substrate 31, and leads 36, 37, ends of which are connected to the upper surface of the nickel plates 34, 35 by spot welding. During the spot welding, spot welding portions 38, 39 and burrs 38a, 39a are formed.

The resin portion 33 is formed by printing a resin material, using a squeegee, onto a large substrate, which is to be divided into a number of the substrates 31.

FIG. 15 is a diagram exemplifying the process of resin printing for forming the resin portion 33.

As shown in FIG. 15, a resin printing mask 40 is set on the substrate 31 to cover the nickel plates 34, 35, and the resin material is supplied into an opening portion 41, thereby forming the resin portion 33.

Probing portions 43, 44 are formed on the lower surface of the resin printing mask 40 in such a way that the probing portions 43, 44 do not interfere with the nickel plates 34, 35.

FIG. 16A and FIG. 16B are perspective views illustrating a protection-circuit board device 50 in the related art.

FIG. 17A and FIG. 17B are a top view and a cross-sectional view of the protection-circuit board device 50.

As shown in FIG. 16A, FIG. 16B, FIG. 17A, and FIG. 17B, the protection-circuit board device 50 includes an elongated rectangular substrate 51; plural electrical parts 52 mounted on the upper surface 51a of the substrate 51; a resin portion 53 burying the electrical parts 52; electrodes 51c on the lower surface 51b of the substrate 51; and elongated nickel plates 54, 55 connected, by soldering, to lands (not illustrated) on the two ends of the upper surface 51a of the substrate 51, and leads 56, 57, ends of which are connected to the upper surface on the other end of the elongated nickel plates 54, 55 by spot welding, thereby forming soldering portions 58, 59, and spot welding portions 60, 61. Here, the spot welding portions 60, 61 are on the elongated nickel plates 54, 55, respectively, and far from the soldering portions 58, 59, respectively, and in order not to affect the soldering portions 58, 59, the thickness t23 of the spot welding portions 60, 61 is as thin as 0.1 mm.

The resin portion 53 is formed by printing a resin material, using a squeegee, onto a large substrate, which is to be divided into a number of the substrates 51.

FIG. 18 is a diagram exemplifying the process of resin printing for forming the resin portion 53.

As shown in FIG. 18, a resin printing mask 70 is set on the substrates 51, and the resin material is supplied into an opening portion 71, thereby forming the resin portion 53.

For example, Japanese Laid Open Patent Application No. 2002-208669 discloses such a technique.

However, in the protection-circuit board device 30 shown in FIG. 13A, FIG. 13B, FIG. 14A, and FIG. 14B, during the spot welding process, in order that the solder for attaching the lands to the nickel plate 34 does not melt, it is necessary that the thickness t15 of the nickel plate 34 be about 0.4 mm. In addition, a clearance g of 0.1 mm is required between the nickel plate 34 and the resin printing mask 40. Due to these two reasons, if the thickness t2 of the resin printing mask 40 is 0.2 mm, the total thickness t16 of the resin printing mask 40 and the nickel plate 34 becomes (t15+g+t2), namely, equals 0.7 mm; accordingly, the thickness t12 of the resin portion 33 should be equal to the thickness t16, namely, 0.7 mm. The maximum thickness tmax of the protection-circuit board device 30 equals the sum of the thickness t11 of the substrates 31 and the thickness t12 of the resin portion 33 (0.7 mm). Assuming the thickness t11 of the substrates 31 is 0.6 mm, the maximum thickness of the protection-circuit board device 30 becomes about 1.3 mm.

Further, the burrs 38a, 39a formed during spot welding also increase the thickness of the nickel plates 34, 35 of the protection-circuit board device 30.

In the protection-circuit board device 50 shown in FIG. 16A, FIG. 16B, FIG. 17A, and FIG. 17B, since it is not necessary to consider the matter of avoiding interference between the elongated nickel plates 54, 55 and the resin printing mask 70, as shown in FIG. 18, the resin printing mask 70 can be made thin. For example, the thickness of the resin portion 53, which is determined by the mounted electrical parts 52, can be made equal to 0.6 mm. However, since the elongated nickel plates 54, 55 are mounted by soldering manually, it is difficult to control the height h of the solder dots, and the height h of the solder dots becomes 0.6 mm. The maximum thickness tmax of the protection-circuit board device 50 corresponds to the thickness of the soldering portions, and equals the sum of the thickness t21 of the substrates 51, the thickness t23 of the elongated nickel plate 54, and the height h of the soldering portions 58. Assuming the thickness t21 of the substrates 51 is 0.6 mm, the thickness t23 of the elongated nickel plate 54 is 0.1 mm, and the height h of the soldering portions 58 is 0.6 mm, the maximum thickness of the protection-circuit board device 50 is about 1.3 mm, similar to that of the protection-circuit board device 30.

### SUMMARY OF THE INVENTION

Accordingly, a general object of the present invention is to solve one or more problems in the related art.

A more specific object of the present invention is to provide a circuit board device able to be made thin.

Another specific object of the present invention is to provide a battery pack having increased capacity.

According to a first aspect of the present invention, there is provided a circuit board device, comprising:

a substrate having a notch at one end thereof;

a plurality of electrical parts mounted on an upper surface of the substrate;

a resin portion burying the electrical parts;

a metal plate fixed at an end portion of the upper surface of the substrate to cover the notch;

a lead connected to the metal plate and extending from the end of the substrate to the outside, one end of said lead being held in the notch and being welded to a back side of the metal plate for connection to the metal plate.

According to a second aspect of the present invention, there is provided a circuit board device, comprising:

a substrate having a notch at one end thereof, said notch being covered by a metal plate and being used to hold an end of a lead with one end of the lead being welded to a back side of the metal plate;

a plurality of electrical parts mounted on an upper surface of the substrate; and

a resin portion burying the electrical parts.

According to a third aspect of the present invention, there is provided a circuit board device, comprising:

a substrate having a notch at one end thereof, said notch being used to hold an end of a lead;

a plurality of electrical parts mounted on an upper surface of the substrate;

a resin portion burying the electrical parts; and

a metal plate fixed at an end portion of the upper surface of the substrate to cover the notch, said metal plate being used for the end of the lead to be welded to a back side of the metal plate.

According to a fourth aspect of the present invention, there is provided a battery pack, comprising:

a cell; and

a circuit board device that monitors an output voltage of the cell and protects the cell,

wherein

the circuit board device includes:

a substrate having a notch at one end thereof;

a plurality of electrical parts mounted on an upper surface of the substrate;

a resin portion burying the electrical parts;

a metal plate fixed at an end portion of the upper surface of the substrate to cover the notch; and

a lead connected to the metal plate and extending from the end of the substrate to the outside, one end of said lead being held in the notch and being welded to a back side of the metal plate for connection to the metal plate.

According to the present invention, the lead is welded to the metal plate, the welding site is far away from the site where the metal plate is connected to the substrate, and thus, heat generated during the welding process does not influence the connection of the metal plate to the substrate, so that the metal plate can be made thin compared to the related art. As a result, the resin portion can be made as thin as possible to be nearly equal the height of the electrical parts, and it is possible to reduce the maximum thickness of the circuit board device compared to the related art.

In addition, since the thickness of the protection-circuit board device is reduced, the dimension of a cell in a battery pack can be increased accordingly; thus the capacity of the battery pack can be increased.

These and other objects, features, and advantages of the present invention will become more apparent from the following detailed description of the preferred embodiments given with reference to the accompanying drawings.

### BRIEF DESCRIPTION OF THE DRAWINGS

FIG. 1A and FIG. 1B are perspective views illustrating a protection-circuit board device 100 according to an embodiment of the present invention.

FIG. 2A is a top view of the protection-circuit board device 100.

FIG. 2B is a cross-sectional view of the protection-circuit board device 100.

FIG. 2C is a bottom view of the protection-circuit board device 100.

FIG. 3A and FIG. 3B are perspective views illustrating the substrate 101 of the protection-circuit board device 100 without the nickel plates 140, 141 being mounted;

FIG. 4A and FIG. 4B are perspective views illustrating the substrate 101 with the nickel plates 140, 141 being mounted;

FIG. 5 is a flow chart illustrating a method of fabricating the protection-circuit board device 100 as described above;

FIG. 6 is a perspective view of a portion of a substrate aggregate 170;

FIG. 7 is a perspective view of a portion of the substrate aggregate 170 for illustrating the surface mounting step;

FIG. 8 is a perspective view of a portion of the substrate aggregate 170 with a resin printing mask 180 mounted thereon, for illustrating the resin printing mounting step;

FIG. 9 is a cross-sectional view of the portion of the substrate aggregate 170 with the resin printing mask 180 mounted thereon, for illustrating the resin printing step;

FIG. 10 is a perspective view of a portion of the substrate aggregate 170 after the resin printing step;

FIG. 11A is an exploded perspective view illustrating a battery pack 10A according to the present embodiment;

FIG. 11B is a cross-sectional view of the battery pack 10A in FIG. 11A;

FIG. 12A is an exploded perspective view illustrating a battery pack in the related art;

FIG. 12B is a cross-sectional view of the battery pack in FIG. 12A;

FIG. 13A and FIG. 13B are perspective views illustrating a protection-circuit board device 30 in the related art;

FIG. 14A and FIG. 14B are a top view and a cross-sectional view of the protection-circuit board device 30;

FIG. 15 is a diagram exemplifying the process of resin printing for forming the resin portion 33;

FIG. 16A and FIG. 16B are perspective views illustrating a protection-circuit board device 50 in the related art;

FIG. 17A and FIG. 17B are a top view and a cross-sectional view of the protection-circuit board device 50; and

FIG. 18 is a diagram exemplifying the process of resin printing for forming the resin portion 53.

### DESCRIPTION OF THE EMBODIMENTS

Below, embodiments of the present invention are explained with reference to the accompanying drawings.

### [Configuration of Protection-Circuit Board Device]

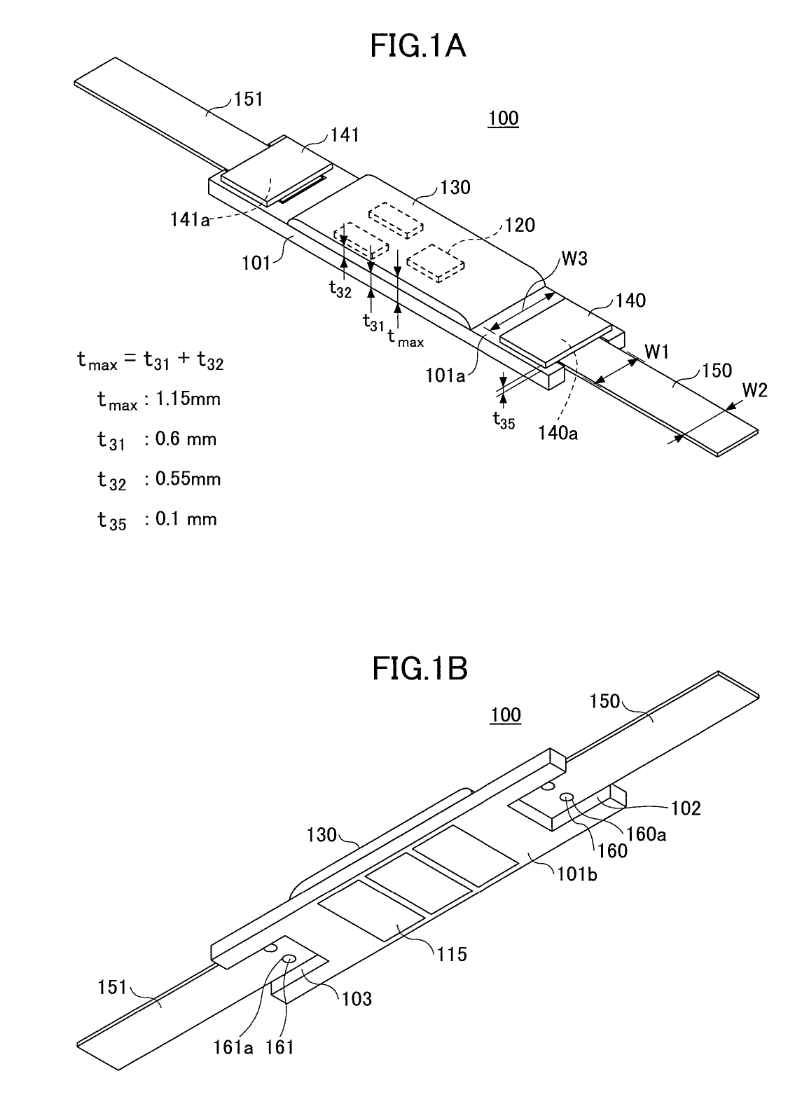

FIG. 1A and FIG. 1B are perspective views illustrating a protection-circuit board device 100 according to an embodiment of the present invention.

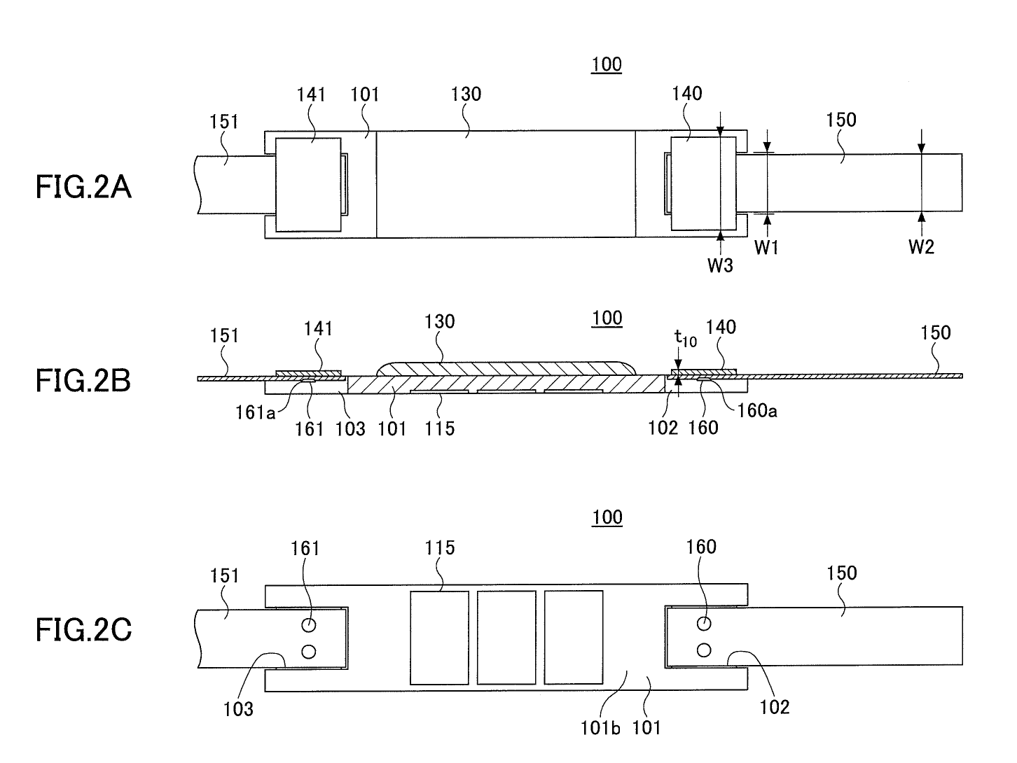

FIG. 2A is a top view of the protection-circuit board device 100.

FIG. 2B is a cross-sectional view of the protection-circuit board device 100.

FIG. 2C is a bottom view of the protection-circuit board device 100.

As shown in FIG. 1A and FIG. 1B, and FIG. 2A through FIG. 2C, the protection-circuit board device 100 includes a substrate 101, plural electrical parts 120 mounted on the upper surface 101a of the substrate 101, a resin portion 130 burying the electrical parts 120, nickel plates 140, 141, and leads 150, 151.

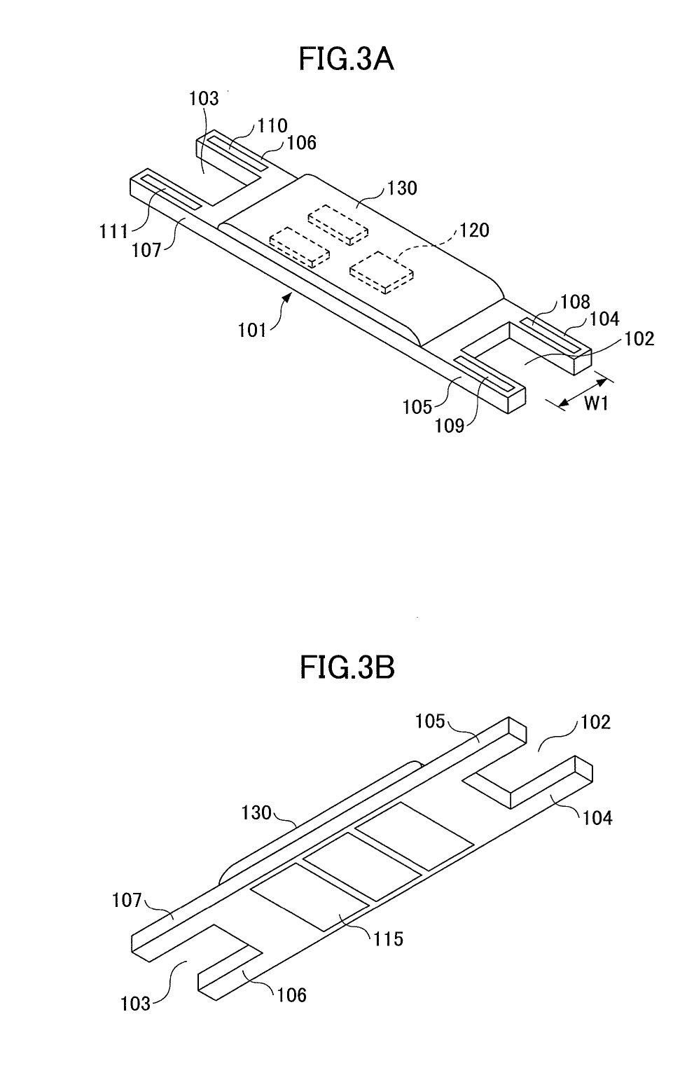

FIG. 3A and FIG. 3B are perspective views illustrating the substrate 101 of the protection-circuit board device 100 without the nickel plates 140, 141 being mounted.

As shown in FIG. 3A and FIG. 3B, and other figures described above, the substrate 101 is a multi-layer elongated rectangle, and has square notches 102, 103 on its two ends, respectively. Around the notches 102, 103, there are two pairs of opposite arm portions 104, 105, 106, and 107, and lands 108, 109, 110 and 111 are formed on the arm portions 104, 105, 106, and 107, respectively.

The size of the notches 102, 103 is appropriately determined so that the ends of the leads 150, 151 can be accommodated, and the nickel plates 140, 141 can bridge over the notches 102, 103. Namely, the width W1 of the notches 102, 103 is slightly greater than the width W2 of the leads 150, 151, but slightly less than the width W3 of the nickel plates 140, 141.

Electrodes 115 are arranged on the back side 101b of the substrate 101.

The plural electrical parts 120 are mounted on the upper surface 101a of the substrate 101, and constitute a cell protection circuit.

The resin portion 130 is provided on the upper surface 101a of the substrate 101 to bury the electrical parts 120.

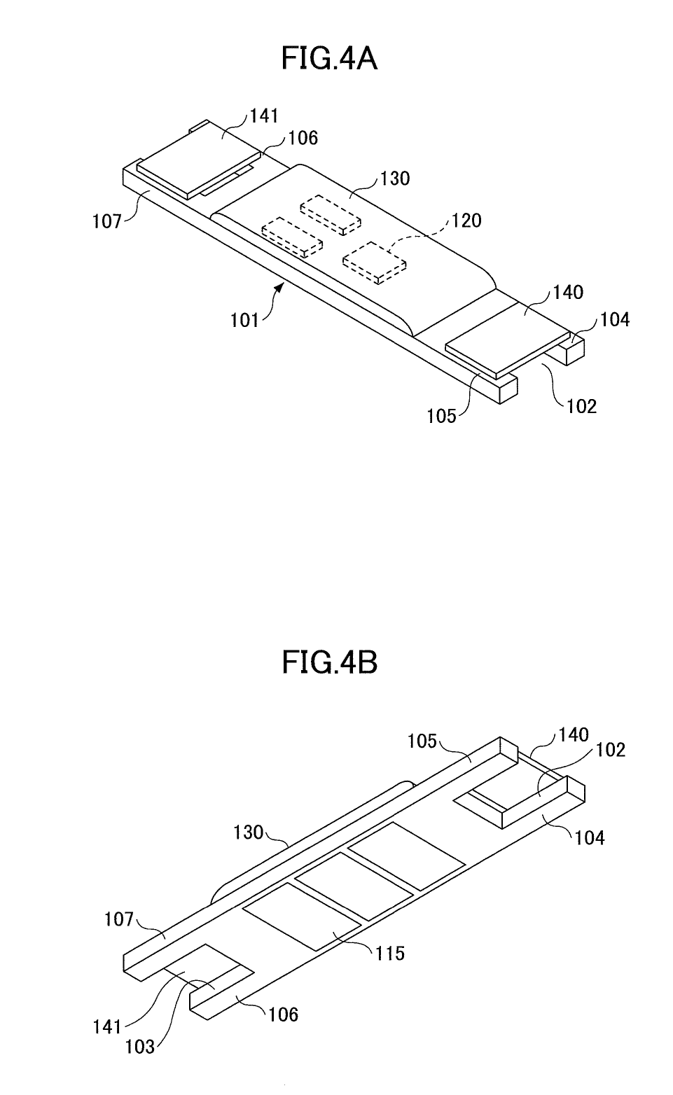

FIG. 4A and FIG. 4B are perspective views illustrating the substrate 101 with the nickel plates 140, 141 being mounted.

As shown in FIG. 4A and FIG. 4B, and other figures described above, lands 108 and 109 (refer to FIG. 3A and FIG. 3B) are connected to the nickel plate 140 by soldering; the nickel plate 140 is provided on the arm portions 104, 105, and thus is fixed on the upper surface 101a of the substrate 101.

As shown in FIG. 1A, FIG. 1B, FIG. 2B and FIG. 2C, the end of the lead 150 is inserted into the notch 102, and is connected to the back surface 140a of the nickel plate 140 by spot-welding at spot-welding portions 160; thus the lead 150 extends from the end of the substrate 101 to the outside. Similarly, the end of the lead 151 is inserted into the notch 103, and is spot-welded to the back surface 141a of the nickel plate 141 at spot-welding portions 161; thus the lead 151 extends from the end of the substrate 101 to the outside. In the course of the spot welding, burrs 160a, 161a are formed.

In the protection-circuit board device 100, the nickel plates 140, 141 function as relay members, and spot-welding is necessary to obtain sufficient strength to connect the nickel plates 140, 141. However, since spot-welding cannot be performed directly on the lands of the substrate, the nickel plates 140, 141 are used as relay members.

### [Fabrication of Protection-Circuit Board Device]

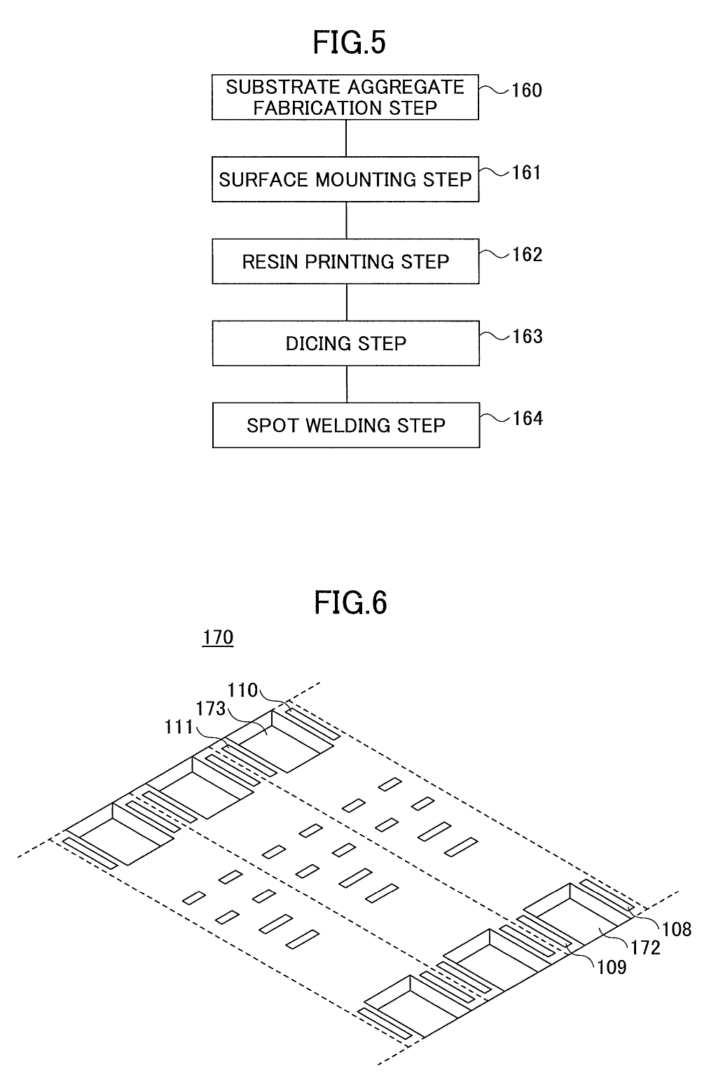

FIG. 5 is a flowchart illustrating a method of fabricating the protection-circuit board device 100 as described above.

Referring to FIG. 5, in the protection-circuit board device 100, on a substrate aggregate, which includes a number of segments corresponding to the substrates 101, respectively, on one segment of an individual substrate 101, the electrical parts 120 and the nickel plates 140, 141 are mounted on the surface 101a by wire bonding.

Next, the resin portion 130 is applied in a lump (at the same time) by printing. Then, the substrate aggregate is divided into plural substrates 101 by dicing. Next, the leads 150, 151 are connected to each of the substrates 101.

### (1) Substrate Aggregate Fabrication Step 160

FIG. 6 is a perspective view of a portion of a substrate aggregate 170.

As shown in FIG. 6, the substrate aggregate 170 includes plural segments arranged in a matrix manner, each of the segments corresponding to an individual substrate 101, and plural openings 172 and openings 173 are arranged at the corresponding ends of the segments, serving as the notches 102 and the notches 103, respectively.

### (2) Surface Mounting Step 161

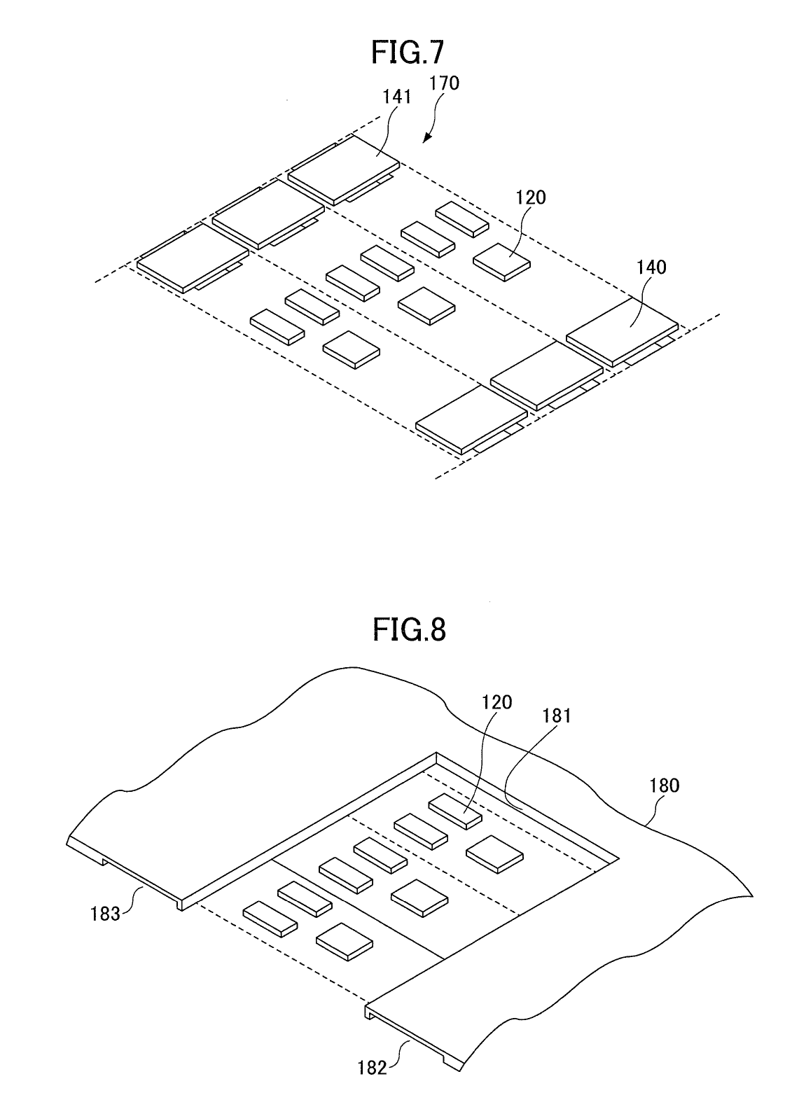

FIG. 7 is a perspective view of a portion of the substrate aggregate 170 for illustrating the surface mounting step.

As shown in FIG. 7, the electrical parts 120 and the nickel plates 140, 141 are mounted on the surface of one segment corresponding to an individual substrate 101. Hence, the substrate aggregate 170 becomes a COB (Chip On Board). Here, since the nickel plates 140, 141 are mounted on the surface of the substrate 101, it is possible reduce the mounting error of the nickel plates 140, 141, and the height of the solder spot is small.

### (3) Resin Printing Step 162

FIG. 8 is a perspective view of a portion of the substrate aggregate 170 with a resin printing mask 180 mounted thereon, for illustrating the resin printing mounting step.

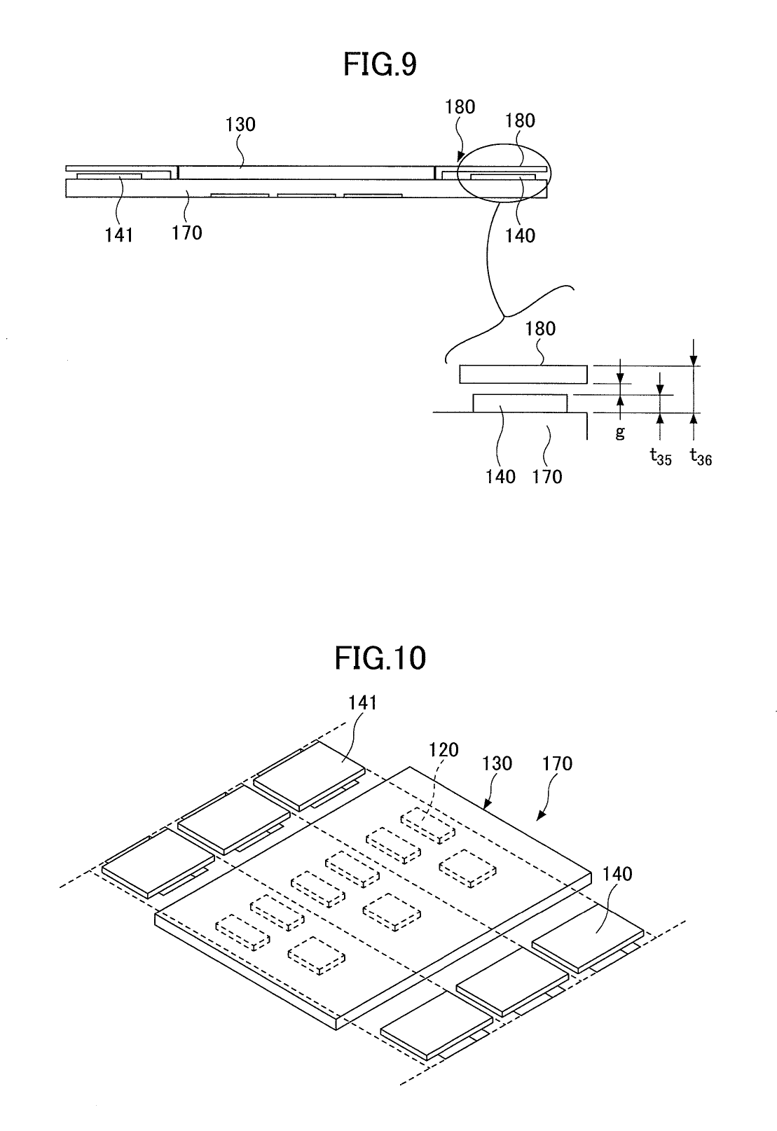

FIG. 9 is a cross-sectional view of the portion of the substrate aggregate 170 with the resin printing mask 180 mounted thereon, for illustrating the resin printing step.

As shown in FIG. 8 and FIG. 9, the resin printing mask 180 is set on the substrate aggregate 170 to cover the nickel plates 140, 141, and a resin material is supplied into an opening portion 181 by using a squeegee.

FIG. 10 is a perspective view of a portion of the substrate aggregate 170 after the resin printing step.

As shown in FIG. 10, by the step of resin printing, the resin portion 130 is formed to cover all of the segments of the substrate aggregate 170 corresponding to all of the substrates 101 in a lump.

Probing portions 182, 183 are formed on the lower surface of the resin printing mask 180 in such way that the probing portions 182, 183 do not interfere with the nickel plates 141, 142.

### (4) Dicing Step 163

The substrate aggregate 170 with the resin portion 130 thereon is divided into plural sections each including one substrate 101 by dicing; thereby the device shown in FIG. 4A and FIG. 4B are obtained.

### (5) Spot Welding Step 164

Each of the sections obtained in step 163 is reversed, and the end of the lead 150 is inserted in the notch 102, and this end portion of the lead 150 is connected to the back surface 140a of the nickel plate 140 by spot welding; similarly, the end of the lead 151 is inserted in the notch 103, and this end portion of the lead 151 is connected to the back surface 141a of the nickel plate 141 by spot welding.

It should be noted that in the above-described surface mounting step 161, mounting of the nickel plates 140, 141 may be omitted, namely, mounting the electrical parts 120 only. In this case, when the substrate aggregate 170 is divided into plural separate sections by dicing, the device shown in FIG. 3A and FIG. 3B are obtained.

### [Maximum Thickness tmax of Protection-Circuit Board Device 100]

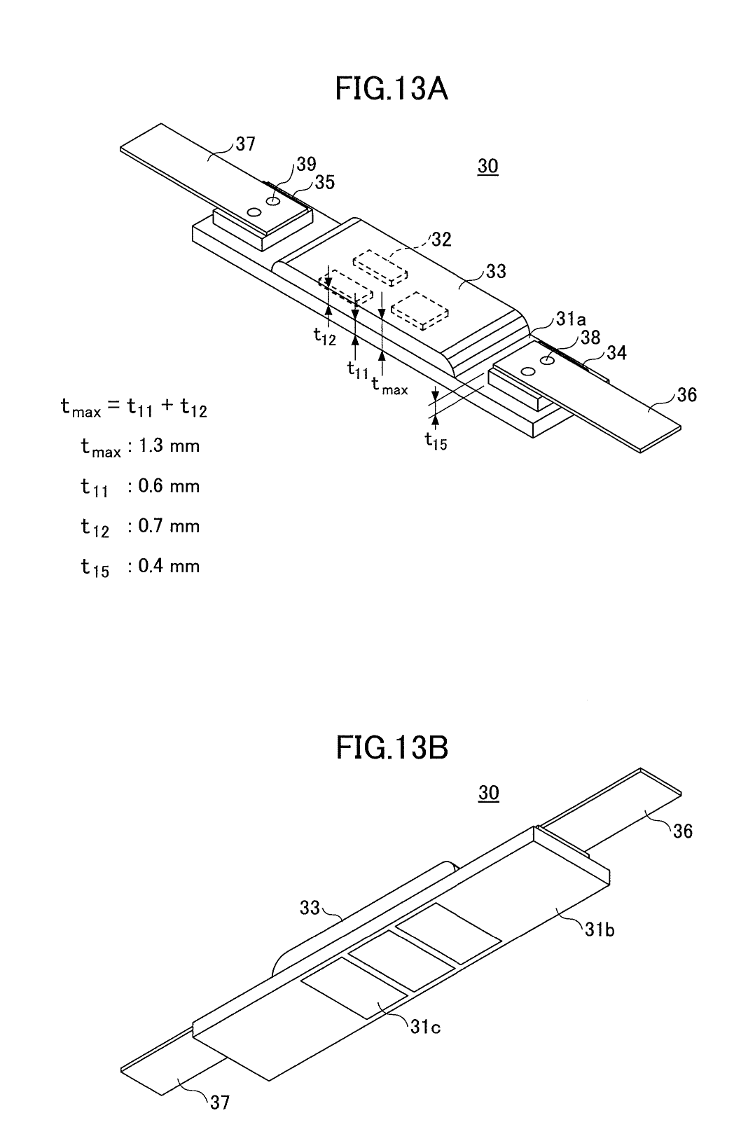

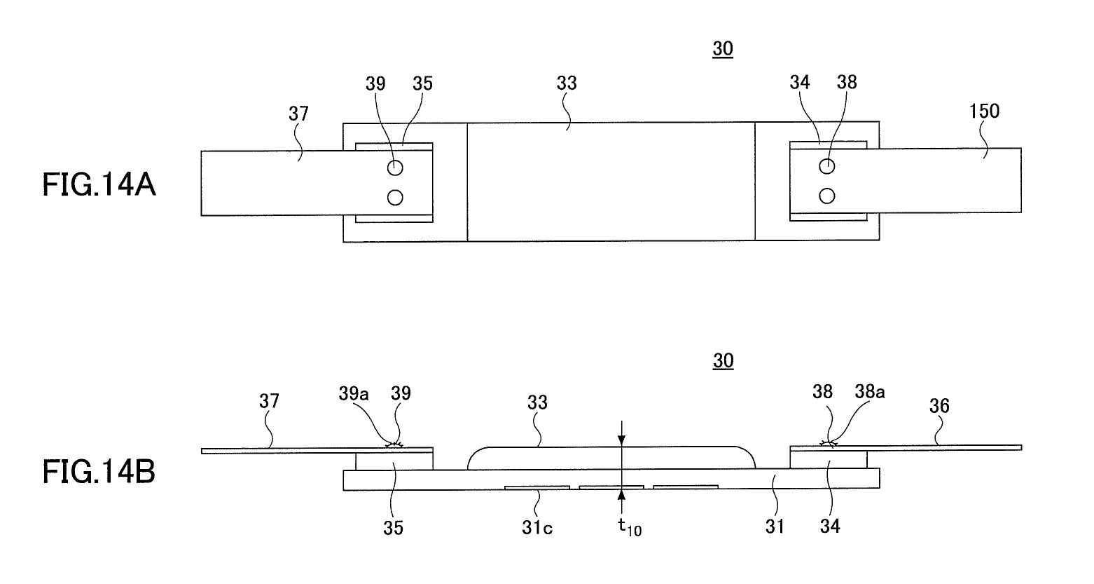

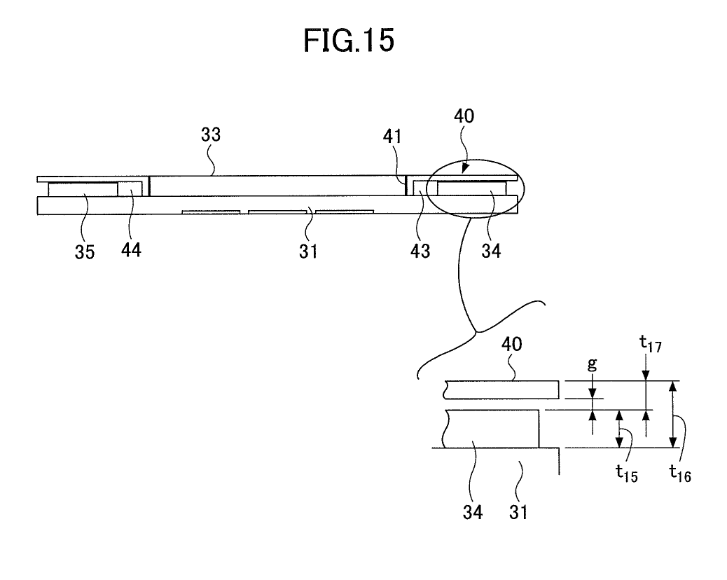

As shown in FIG. 1A and FIG. 1B, since the spot welding sites on the nickel plates 140, 141 are far away from the soldering sites, heat generated during the spot welding does not affect the soldering sites, so the thickness t35 of the nickel plates 140, 141 can be made less than the thickness t15 of the nickel plate 34 in FIG. 13, for example, the thickness t35 may be about 0.1 mm. For this reason, with a clearance g of 0.1 mm existing between the nickel plates 140, 141 and the resin printing mask 180, as shown in FIG. 9, for example, the total thickness t36 of the resin printing mask 180 and the nickel plate 140 can be made as thin as about 0.55 mm, which thickness is also less than the thickness t16 including the resin printing mask 40, as shown in FIG. 15.

Therefore, in the protection-circuit board device 100, for example, the minimum thickness t32 of the resin portion 130 necessary to cover the electrical parts 120 can be as thin as 0.55 mm.

In addition, all of the leads 150, 151, the spot-welding portions 160, 161, and the burrs 160a, 161a are formed not to exceed the thickness of the substrate 101.

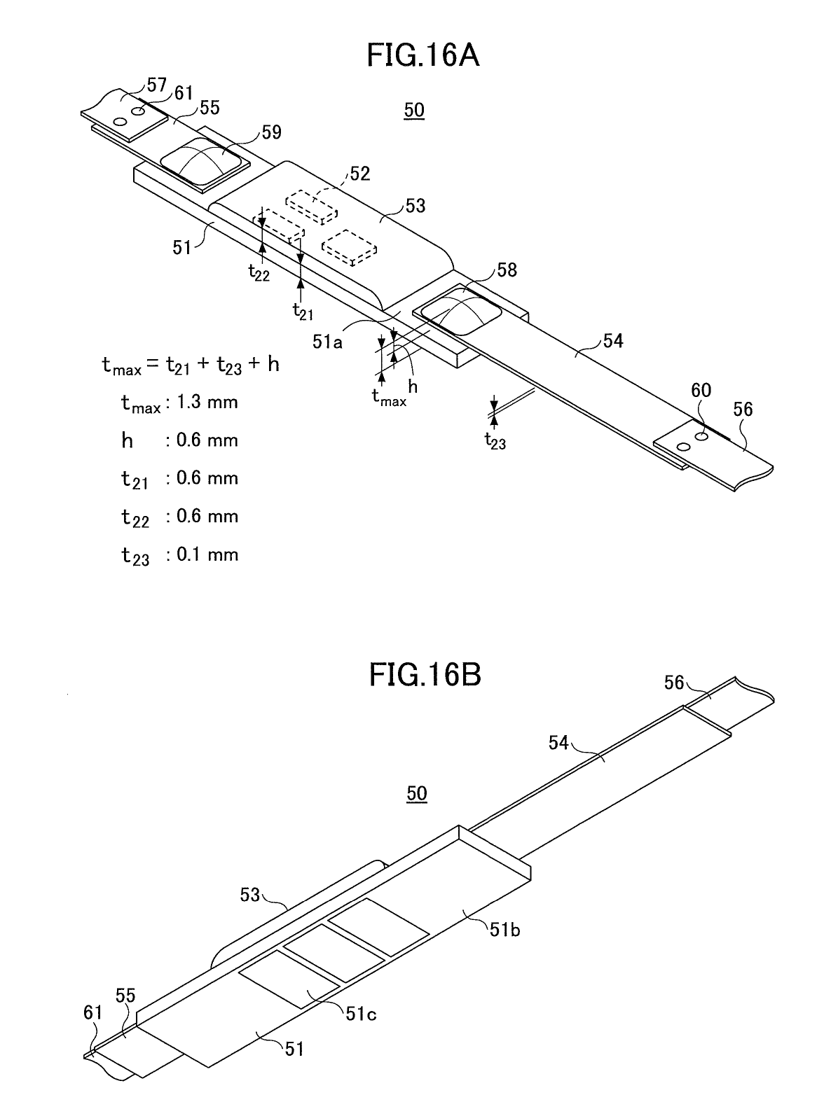

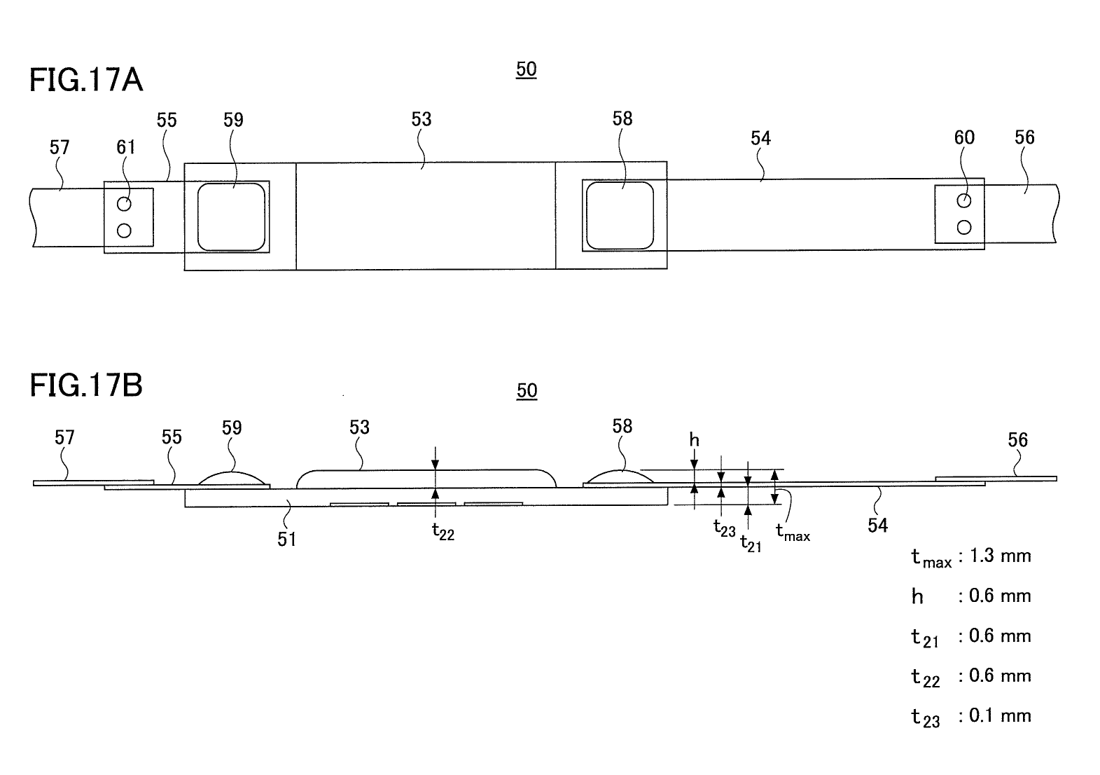

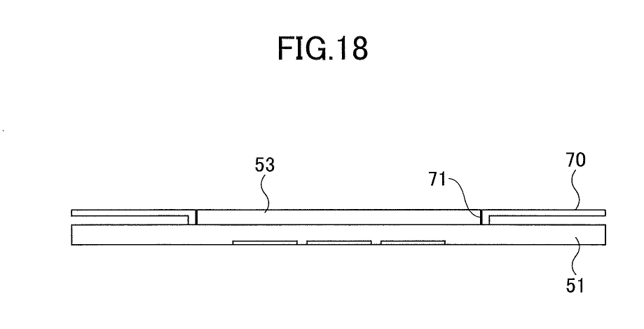

As shown in FIG. 1A, the maximum thickness tmax of the protection-circuit board device 100 equals the sum of the thickness t31 of the substrate 101 and the thickness t32 of the resin portion 130. As described above, the thickness t32 of the resin portion 130 is 0.55 mm, and assuming the thickness t31 of the substrates 101 is 0.6 mm, the maximum thickness tmax of the protection-circuit board device 100 becomes about 1.15 mm. This thickness is less than the maximum thickness of the protection-circuit board devices 30, 50 of the related art, as shown in FIG. 13 and FIG. 16, by 0.15 mm.

### [Battery Pack 10A]

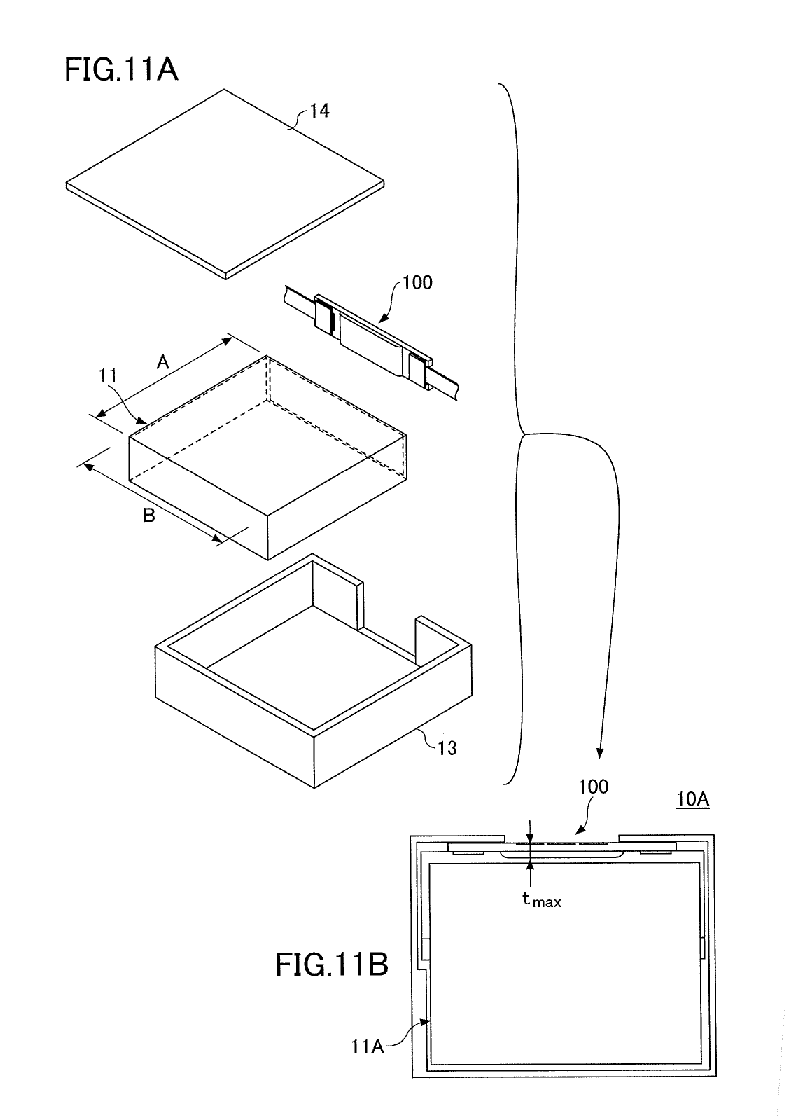

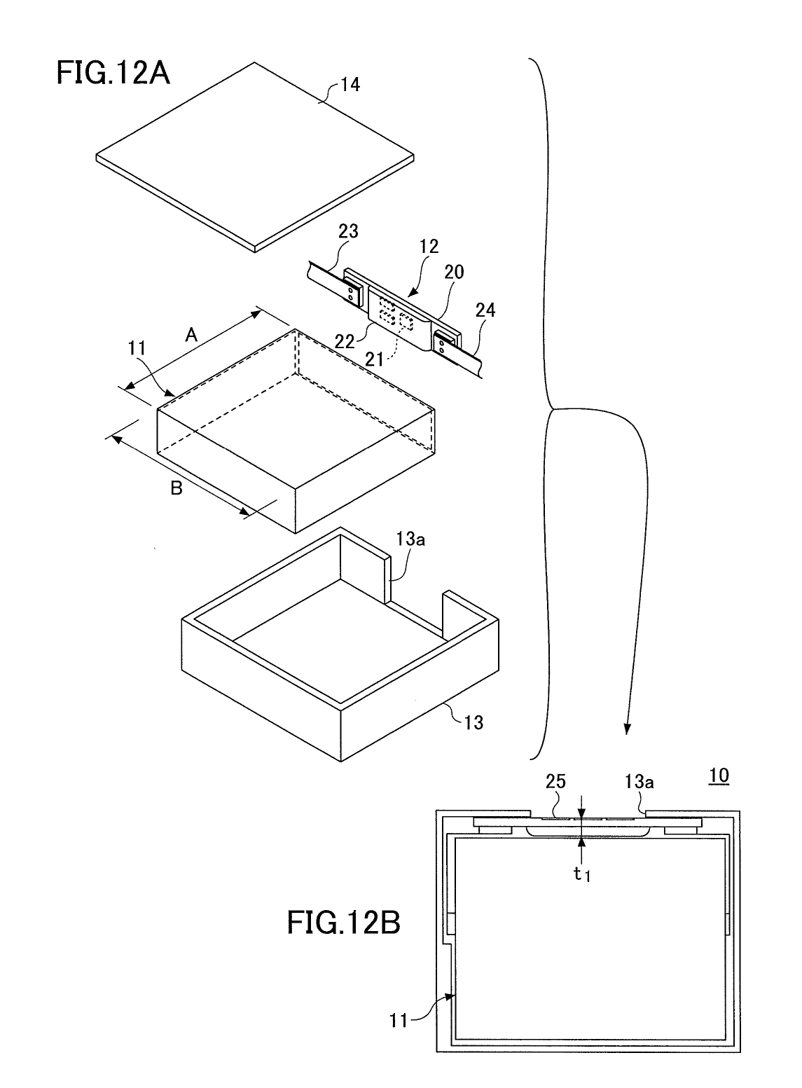

FIG. 11A is an exploded perspective view illustrating a battery pack 10A according to the present embodiment.

FIG. 11B is a cross-sectional view of the battery pack 10A in FIG. 11A.

As shown in FIG. 11A and FIG. 11B, the battery pack 10A includes a cell 11A, the protection-circuit board device 100 as described above, a case 13, and a cover 14. Since the maximum thickness tmax of the protection-circuit board device 100 is reduced, the length A1 of the cell 11A in the vertical direction in FIG. 11A can be increased accordingly. Thus, even though the battery pack 10A has the same size as the battery pack 10 of the related art, the capacity of the battery pack 10A is increased.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Application No. 2006-176971 filed on Jun. 27, 2006, the entire contents of which are hereby incorporated by reference.

What is claimed is:

1. A circuit board device, comprising:
a substrate having a notch at one end thereof;
a plurality of electrical parts mounted on an upper surface of the substrate;
a resin portion burying the electrical parts;
a metal plate fixed at an end portion of the upper surface of the substrate to cover the notch;
a lead connected to the metal plate and extending from the end of the substrate to the outside, one end of said lead being held in the notch and being welded to a back side of the metal plate for connection to the metal plate.

2. A circuit board device, comprising:
a substrate having a notch at one end thereof, said notch being covered by a metal plate and being used to hold an end of a lead with one end of the lead being welded to a back side of the metal plate;
a plurality of electrical parts mounted on an upper surface of the substrate; and
a resin portion burying the electrical parts.

3. A circuit board device, comprising:
a substrate having a notch at one end thereof, said notch being used to hold an end of a lead;
a plurality of electrical parts mounted on an upper surface of the substrate;
a resin portion burying the electrical parts;
a metal plate fixed at an end portion of the upper surface of the substrate to cover the notch, said metal plate being used for the end of the lead to be welded to a back side of the metal plate.

4. A battery pack, comprising:
a cell; and
a circuit board device that monitors an output voltage of the cell and protects the cell;
wherein
the circuit board device includes
a substrate having a notch at one end thereof;
a plurality of electrical parts mounted on an upper surface of the substrate;
a resin portion burying the electrical parts;
a metal plate fixed at an end portion of the upper surface of the substrate to cover the notch; and
a lead connected to the metal plate and extending from the end of the substrate to the outside, one end of said lead being held in the notch and being welded to a back side of the metal plate for connection to the metal plate.
